(19) United States
(12) Patent Application Publication
(10) Pub. No.: US 2004/0188385 A1
(43) Pub. Date: Sep. 30, 2004

(54) Etching agent composition for thin films having high permittivity and process for etching

(76) Inventors: Kenji Yamada, Tokyo (JP); Masaru Ohto, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/793,900

(22) Filed: Mar. 8, 2004

(30) Foreign Application Priority Data
Mar. 26, 2003 (JP) 2003-084473

(51) Int. Cl. B44C 1/22; C23F 1/00

(52) U.S. Cl. 216/83

(57) ABSTRACT

An etching agent composition for thin films having a high permittivity which is an aqueous solution comprising at least one acid selected from organic acids and inorganic acids and a fluorine compound and a process which comprises etching a thin film having a high permittivity using the composition are provided. The composition and the process are used in the process for producing semiconductor devices using thin films having a high permittivity and, in particular, very thin gate insulation films and very thin gate electrodes which are indispensable for enhancing integration and speed of MOSFET.

### TECHNICAL FIELD

The present invention relates to an etching agent composition for thin films having a high permittivity which is used in the process for producing semiconductor devices using thin films having a high permittivity and, in particular, very thin gate insulation films and very thin gate electrodes which are indispensable for enhancing integration and speed of MOSFET (Metal-Oxide-Semiconductor Field Effect Transistor) and a process for etching using the composition.

### BACKGROUND ART

Due to excellent stability of processes and excellent insulation, silicone oxide films are used as the material of gate insulation films in MOSFET. As semiconductor devices becomes finer recently, the gate insulation films are becoming thinner. When the length of a gate decreases to 100 nm or smaller, it is necessary that the thickness of the silicon oxide film used as the gate insulation film be 1.5 nm or smaller due to the requirement of the scaling rule. However, when a very thin film such as that required above is used, the tunnel current across the insulation film formed by application of a gate bias voltage increases to a value which cannot be neglected in comparison with the source and drain currents, and this is the great problem for achieving further improvement in properties and decreasing the consumption of electricity of MOSFET.

Research and development on decreasing the effective thickness of the gate insulation films and suppressing the tunnel current within the value allowable in the design of the device are being conducted. In one of such studies, the permittivity is increased in comparison with that of the pure silicon oxide film by adding nitrogen to a silicon oxide film, and the effective thickness of the gate insulation film is decreased without decreasing the physical thickness. However, it has been pointed out that there is the limit in the increase in the permittivity by addition of nitrogen to the silicon oxide film.

In another of such studies, a material for thin films having a dielectric constant of 10 or greater or a silicate material for thin films which is a composite material of a material having a dielectric constant of 10 or greater and silicon is used for the gate insulation film in place of the silicon oxide film having a dielectric constant of 3.9. As the candidate for the above material for thin films having a high permittivity, Al₂O₃, ZrO₂, HfO₂, oxides of rare earth elements such as Y₂O₃ and oxides of Lanthanoid elements have been studied. When the above thin film having a high permittivity is used, the thickness sufficient for preventing the tunnel current across the gate insulation film can be obtained while the capacity of the gate insulation film in accordance with the scaling rule is maintained even when the length of the gate is decreased.

However, when a semiconductor device using the thin film having a high permittivity which uses the oxide of a rare earth element or a Lanthanoid element as the material is produced, the fine working becomes difficult in the production conducted simply in accordance with the conventional dry etching processes using a gas. Therefore, development of an agent suitable for the etching of the thin film having a high permittivity has been desired.

The present invention has an object of providing an etching agent composition which is effective for fine working, which is difficult in the production conducted in accordance with the conventional dry etching processes using a gas, and causes little corrosion of other wiring materials and substrates in the process for producing semiconductor devices using thin films having a high permittivity and, in particular, very thin gate insulation films and very thin gate electrodes which are indispensable for enhancing integration and speed of MOSFET, and a process using the composition.

### DISCLOSURE OF THE INVENTION

As the result of intensive studies by the present inventors to overcome the above problem, it was found that an etching agent composition which was an aqueous solution containing at least one of organic acids and inorganic acids and a fluorine compound exhibited an excellent property in that fine working of thin films having a high permittivity could be conducted and little corrosion of wiring materials and substrates took place. The present invention has been completed based on this knowledge.

The present invention provides the etching agent composition for thin films having a high permittivity and a process for producing a thin film having a high permittivity as follows.

(1) An etching agent composition for thin films having a high permittivity which is an aqueous solution comprising at least one acid selected from organic acids and inorganic acids and a fluorine compound.

(2) An etching agent composition described above in (1), wherein a concentration of the organic acid is in a range of 0.01 to 15% by weight, and a concentration of the fluorine compound is in a range of 0.001 to 10% by weight in the aqueous solution.

(3) An etching agent composition described above in any one of (1) and (2), wherein the organic acid is at least one acid selected from oxalic acid, citric acid, malonic acid, succinic acid, acetic acid and propionic acid.

(4) An etching agent composition described above in (1), which comprises 0.01 to 50% by weight of the inorganic acid and 0.001 to 10% by weight of the fluorine compound.

(5) An etching agent composition described above in any one of (1) and (4), wherein the inorganic acid is at least one acid selected from sulfuric acid, nitric acid, hydrochloric acid, phosphoric acid and sulfamic acid.

(6) An etching agent composition described above in any one of (1) to (5), wherein the fluorine compound is hydrofluoric acid, ammonium fluoride or tetramethylammonium fluoride.

(7) An etching agent composition described above in any one of (1) to (6), wherein the material of the thin film having a high permittivity is a material comprising at least one compound selected from ZrO₂, Ta₂O₅, Nb₂O₅, Al₂O₃, HfO₂, HfSiON, TiO₂, ScO₃, Y₂O₃, La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃, a silicate material comprising any of these compounds and silicon or a nitride material comprising any of these compounds and nitrogen.

(8) A process for etching a thin film having a high permittivity which comprises etching a thin film having a high permittivity using an aqueous solution comprising at least one acid selected from organic acids and inorganic acids and a fluorine compound.

(9) A process for etching a thin film having a high permittivity described above in (8), wherein a concentration of the organic acid is in a range of 0.01 to 15% by weight, and a concentration of the fluorine compound is in a range of 0.001 to 10% by weight in the aqueous solution.

(10) A process for etching a thin film having a high permittivity described above in any one of (8) and (9), wherein the organic acid is at least one acid selected from oxalic acid, citric acid, malonic acid, succinic acid, acetic acid and propionic acid.

(11) A process for etching a thin film having a high permittivity described above in (8), wherein the aqueous solution comprises 0.01 to 50% by weight of the inorganic acid and 0.001 to 10% by weight of the fluorine compound.

(12) A process for etching a thin film having a high permittivity described above in any one of (8) and (11), wherein the inorganic acid is at least one acid selected from sulfuric acid, nitric acid, hydrochloric acid, phosphoric acid and sulfamic acid.

(13) A process for etching a thin film having a high permittivity described above in any one of (8) to (12), wherein the fluorine compound is hydrofluoric acid, ammonium fluoride or tetramethylammonium fluoride.

(14) A process for etching a thin film having a high permittivity described above in any one of (8) to (13), wherein the material of the thin film having a high permittivity is a material comprising at least one compound selected from ZrO₂, Ta₂O₅, Nb₂O₅, Al₂O₃, HfO₂, HfSiON, TiO₂, ScO₃, Y₂O₃, La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃, a silicate material comprising any of these compounds and silicon or a nitride material comprising any of these compounds and nitrogen.

### BRIEF DESCRIPTION OF THE DRAWINGS

FIG. 1 shows a diagram schematically exhibiting a section of a wafer sample having an SiO₂ film formed on a silicon wafer substrate and a HfO₂ film formed on the SiO₂ film.

### THE MOST PREFERRED EMBODIMENT TO CARRY OUT THE INVENTION

Examples of the organic acid used in the present invention include oxalic acid, citric acid, malonic acid, succinic acid, acetic acid, maleic acid, glycolic acid, diglycolic acid, tartaric acid, itaconic acid, pyruvic acid, malic acid, adipic acid, formic acid, phthalic acid, benzoic acid, salicylic acid, carbamic acid, thiocyanic acid and lactic acid. Among these organic acids, oxalic acid, citric acid, malonic acid, succinic acid, acetic acid and propionic acid.

Examples of the inorganic acid include sulfuric acid, nitric acid, hydrochloric acid, phosphoric acid, hypophosphorous acid, carbonic acid, sulfamic acid and boric acid. Among these inorganic acid, sulfuric acid, nitric acid, hydrochloric acid, phosphoric acid and sulfamic acid are preferable.

The above organic acid and the inorganic acid used in the present invention may be used singly or in combination of two or more. The concentration of the organic acid in the etching agent composition of the present invention is suitably decided in accordance with the solubility into water dissolving the acid. It is preferable that the concentration of the organic acid is in the range of 0.01 to 15% by weight and more preferably in the range of 0.5 to 10% by weight. When the concentration of the organic acid is smaller than 0.01% by weight, the rate of etching the thin film having a high permittivity decreases. When the concentration exceeds 15% by weight, crystals are separated in the etching agent composition. Therefore, a concentration outside the above range is not preferable.

The concentration of the inorganic acid is suitably decided in accordance with the solubility in water. It is preferable that the inorganic acid is used in an amount in the range of 0.01 to 50% by weight. When the concentration is smaller than 0.01% by weight, the rate of etching the thin film having a high permittivity decreases. When the concentration exceeds 50% by weight, etching takes place on materials which are present in combination with the thin film having a high permittivity of the object of the etching and are desired to be prevented from damages by the etching. Therefore, a concentration outside the above range is not preferable.

Examples of the fluorine compound used in the present invention include hydrofluoric acid, ammonium fluoride, acidic ammonium fluoride, fluorides of organic amines such as monoethanolamine fluoride, methylamine hydrofluoride, ethylamine hydrofluoride and propylamine hydrofluoride, tetramethylammonium fluoride, tetraethylammonium fluoride, triethylmethylammonium fluoride, trimethylhydroxyethylammonium fluoride, tetraethanolammonium fluoride and methyltriethanolammonium fluoride. Among these fluorine compounds, hydrofluoric acid, ammonium fluoride and tetramethylammonium fluoride are preferable.

The fluorine compound used in the present invention may be used singly or in combination of two or more. The concentration of the fluorine compound is in the range of 0.001 to 10% by weight, preferably in the range of 0.005 to 5% by weight and more preferably in the range of 0.01 to 3% by weight. When the concentration of the fluorine compound is smaller than 0.001% by weight, the rate of etching of the thin film having a high permittivity decreases. When the concentration exceeds 10% by weight, corrosion of wiring materials and substrates takes place. Therefore, a concentration outside the above range is not preferable.

Where desired, the etching agent composition of the present invention may further comprise conventional additives as long as the object of the present invention is not adversely affected. A surfactant may be added to improve the wetting property of the etching agent composition. Examples of the surfactant include cationic surfactants, nonionic surfactants and anionic surfactants. pH of the etching agent composition of the present invention is not particularly limited. In general, pH is in the range of 1 to 12 and is suitably selected in accordance with the condition of the etching and the type of the semiconductor substrate. When the etching agent composition is used in an alkaline condition, for example, ammonia, an amine or a quaternary ammonium hydroxide such as tetramethylammonium hydroxide may be added. When the etching agent composition is used in an acidic condition, an organic acid or an inorganic acid may be added.

The etching agent composition of the present invention can be used at a temperature in the range of the ordinary temperature to 90° C. The temperature can be suitably decided in accordance with the type of the material of the thin film having a high permittivity used for the etching and the required amount of etching with the consideration on the time of the etching.

The material of the thin film having a high permittivity in the present invention is a material comprising at least one compound selected from ZrO₂, Ta₂O₅, Nb₂O₅, Al₂O₃, HfO₂, HfSiON, TiO₂, ScO₃, Y₂O₃, La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃. It is preferable that the material comprises at least one compound selected from ZrO₂, Ta₂O₅, Al₂O₃ and HfO₂. The material may also be a silicate material comprising silicon in combination with the above compound or a nitride material comprising nitrogen in combination with the above compound. The material may also be a mixture or a laminate of two materials described above.

### EXAMPLES

The present invention will be described more specifically with reference to examples in the following. However, the present invention is not limited to the examples.

### Example 1

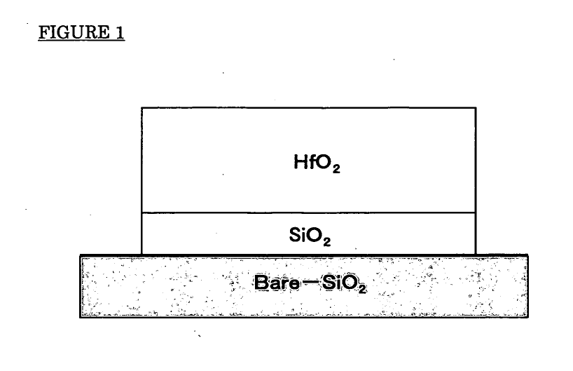

Using a wafer sample having an SiO₂ film formed on a silicon wafer substrate and a HfO₂ film formed on the SiO₂ film (FIG. 1), the amount of etching of HfO₂ was measured. The thickness of the HfO₂ film on the substrate shown in FIG. 1 was measured using a optical thickness meter, and the obtained value was used as the initial thickness. The sample was dipped into an etching agent composition which was an aqueous solution containing 3% by weight of oxalic acid and 0.05% by weight of hydrofluoric acid at 50° C. for 10 minutes, rinsed with water and dried. Then, the thickness of the HfO₂ film was measured again using the optical thickness meter, and the obtained value was used as the thickness after the treatment. The amount of etching of the HfO₂ film was calculated from the initial thickness and the thickness after the treatment of the HfO₂ film and was found to be 38.5 Å.

On the other hand, using a wafer sample having an SiO₂ film alone formed on a silicon wafer substrate, the amount of etching of the SiO₂ film was obtained in accordance with the same procedures as those conducted above and was found to be 16.5 Å. Therefore, the ratio of the amount of etching of the HfO₂ film to that of the SiO₂ film was 2.3.

### Examples 2 to 5 and Comparative Example 1 to 3

Using the same substrate as that used in Example 1 (FIG. 1), the treatments with the etching agent compositions shown in Table 1 were conducted, and the amounts of etching of the HfO₂ film and the SiO₂ film were measured. The results are shown in Table 1.

TABLE 1-1

| | | | | | Concentration |
|---|---|---|---|---|---|
| | Acid | | Fluorine compound | | of |
| | | concentration | | concentration | water |
| | compound | (% by wt) | compound | (% by wt) | (% by wt) |
| Example | | | | | |
| 2 | oxalic acid | 3.0 | ammonium fluoride | 0.4 | 96.6 |
| 3 | succinic acid | 6.0 | ammonium | 0.05 | 93.95 |
| | | | hydrogen fluoride | | |
| 4 | malonic acid | 1.5 | tetramethylammonium | 1.0 | 95.5 |
| | | | hydrofluoride | | |
| 5 | citric acid | 3.0 | ammonium fluoride | 0.2 | 96.8 |
| Comparative | | | | | |
| Example | | | | | |
| 1 | oxalic acid | 5.0 | — | — | 95 |
| 2 | — | — | tetramethylammonium | 5.0 | 95 |
| | | | hydrofluoride | | |
| 3 | hydrochloric acid | 36 | — | — | 64 |

TABLE 1-2

| | | | Amount | | |
|---|---|---|---|---|---|
| | | | of etching | | Ratio of |
| | Condition of treatment | | HfO₂ | | amounts of |
| | temperature | time | film | SiO₂ film | etching |
| | (° C.) | (minute) | (Å) | (Å) | HfO₂/SiO₂ |
| Example | | | | | |
| 2 | 45 | 10 | 118 | 72.6 | 1.6 |
| 3 | 25 | 10 | 48 | 13 | 3.7 |
| 4 | 35 | 10 | 83 | 57 | 1.6 |
| 5 | 25 | 10 | 62 | 24 | 2.6 |
| Comparative | | | | | |
| Example | | | | | |
| 1 | 70 | 10 | 0 | 1 | — |
| 2 | 40 | 10 | 9 | 170 | 0.05 |
| 3 | 50 | 10 | 0 | 4 | — |

### Comparative Example 4

The same substrate as that used in Example 1 (FIG. 1) was dipped into a composition composed of 20% of tetramethylammonium hydroxide and the rest amount of water at 70° C. for 30 minutes, rinsed and dried. The measurement of the thickness of the treated film was attempted using the optical thickness meter. However, the surface of the substrate had irregular stains, and the measurement after the treatment was not possible.

### Examples 6 to 9 and Comparative Examples 5 to 7

Using wafer samples which had the same structure as that in Example 1 except that an Al₂O₃ layer was disposed in place of the HfO₂ layer, the treatments with etching agent compositions shown in Table 2 were conducted, and the amounts of etching of the Al₂O₃ film and the SiO₂ film were measured. The results are shown in Table 2.

TABLE 2-1

| | | | | | Concentration |
|---|---|---|---|---|---|
| | Acid | | Fluorine compound | | of |
| | | concentration | | concentration | water |
| | compound | (% by wt) | compound | (% by wt) | (% by wt) |
| Example | | | | | |
| 6 | oxalic acid | 3.0 | ammonium fluoride | 0.4 | 96.6 |
| 7 | succinic acid | 6.0 | ammonium | 0.05 | 93.95 |
| | | | hydrogen fluoride | | |
| 8 | malonic acid | 1.5 | tetramethylammonium | 1.0 | 95.5 |
| | | | hydrofluoride | | |
| 9 | citric acid | 3.0 | ammonium fluoride | 0.2 | 96.8 |
| Comparative | | | | | |
| Example | | | | | |
| 5 | oxalic acid | 5.0 | — | — | 95 |
| 6 | — | — | tetramethylammonium | 5.0 | 95 |
| | | | hydrofluoride | | |
| 7 | hydrogen | 5 | — | — | 95 |
| | peroxide | | | | |

TABLE 2-2

| | | | | | Ratio of |
|---|---|---|---|---|---|
| | | | Amount | | amounts |
| | | | of etching | | of |
| | Condition of treatment | | Al₂O₃ | | etching |
| | temperature | time | film | SiO₂ film | Al₂O₃/ |
| | (° C.) | (minute) | (Å) | (Å) | SiO₂ |
| Example | | | | | |
| 6 | 50 | 10 | 128 | 82.5 | 1.6 |
| 7 | 25 | 10 | 40 | 13 | 3.1 |
| 8 | 35 | 10 | 96 | 57 | 1.7 |
| 9 | 25 | 10 | 59 | 24 | 2.5 |
| Comparative | | | | | |
| Example | | | | | |
| 5 | 50 | 5 | 1 | 1 | 1 |
| 6 | 40 | 5 | 10 | 85 | 0.1 |
| 7 | 50 | 10 | 3 | 6 | 0.5 |

### Examples 10 to 13 and Comparative Examples 8 to 11

Using wafer samples which had the same structure as that in Example 1 except that an HfSiON layer was disposed in place of the HfO₂ layer, the treatments with etching agent compositions shown in Table 2 were conducted, and the amounts of etching of the HfSiON film and the SiO₂ film were measured. The results are shown in Table 3.

TABLE 3-1

| | | | | | Concentration |
|---|---|---|---|---|---|
| | Acid | | Fluorine compound | | of |
| | | concentration | | concentration | water |
| | compound | (% by wt) | compound | (% by wt) | (% by wt) |
| Example | | | | | |
| 10 | sulfuric acid | 1.0 | tetramethylammonium | 0.2 | 98.8 |
| | | | hydrofluoride | | |
| 11 | sulfuric acid | 1.5 | hydrofluoric acid | 0.1 | 98.4 |
| 12 | hydrochloric acid | 2.0 | tetramethylammonium | 0.1 | 97.9 |
| | | | hydrofluoride | | |
| 13 | hydrochloric acid | 1.0 | ammonium fluoride | 0.2 | 98.8 |
| Comparative | | | | | |
| Example | | | | | |
| 8 | sulfuric acid | 2.0 | — | — | 98 |
| 9 | — | — | tetramethylammonium | 3 | 97 |
| | | | hydrofluoride | | |
| 10 | — | — | hydrofluoric acid | 0.1 | 99.9 |

TABLE 3-2

| | | | | | Ratio of |
|---|---|---|---|---|---|
| | | | | | amounts |
| | | | Amount of etching | | of |
| | Condition of treatment | | | SiO₂ | etching |
| | temperature | time | HfSiON film | film | HfSiON/ |
| | (° C.) | (minute) | (Å) | (Å) | SiO₂ |
| Example | | | | | |
| 10 | 50 | 30 | 260 | 7 | 37.1 |
| 11 | 40 | 10 | 101 | 83 | 1.2 |
| 12 | 50 | 5 | 55 | 3 | 18.3 |
| 13 | 40 | 10 | 143 | 28 | 5.1 |
| Comparative | | | | | |
| Example | | | | | |
| 8 | 50 | 5 | 1 | 3 | 0.3 |
| 9 | 40 | 5 | 9 | 62 | 0.1 |
| 10 | 25 | 10 | 13 | 27 | 0.5 |

When the amount of etching of the HfO₂ film, the Al₂O₃ film or the HfSiON film is compared with that of the SiO₂ film in Tables 1, 2 and 3, it is shown that the amount of etching of the HfO₂ film, the film Al₂O₃ or the HfSiON film is greater than that of the SiO₂ film in Examples 1 to 9.

As shown in the above, when the thin film having a high permittivity is etched using the etching agent composition of the present invention, the etching of the films of Al₂O₃, ZrO₂, HfO₂, HfSiON, rare earth elements such as Y₂O₃ and Lanthanoid elements can be effectively conducted.

Industrial Applicability

When a thin film having a high permittivity is etched using the etching agent composition of the present invention, fine working which is difficult in the production conducted simply in accordance with the conventional processes using a gas is made possible, and damages due to corrosion of various wiring materials and substrates can be suppressed.

1. An etching agent composition for thin films having a high permittivity which is an aqueous solution comprising at least one acid selected from organic acids and inorganic acids and a fluorine compound.

2. An etching agent composition according to claim 1, wherein a concentration of the organic acid is in a range of 0.01 to 15% by weight, and a concentration of the fluorine compound is in a range of 0.001 to 10% by weight in the aqueous solution.

3. An etching agent composition according to any one of claims 1 and 2, wherein the organic acid is at least one acid selected from oxalic acid, citric acid, malonic acid, succinic acid, acetic acid and propionic acid.

4. An etching agent composition according to claim 1, which comprises 0.01 to 50% by weight of the inorganic acid and 0.001 to 10% by weight of the fluorine compound.

5. An etching agent composition according to any one of claims 1 and 4, wherein the inorganic acid is at least one acid selected from sulfuric acid, nitric acid, hydrochloric acid, phosphoric acid and sulfamic acid.

6. An etching agent composition according to any one of claims 1 to 5, wherein the fluorine compound is hydrofluoric acid, ammonium fluoride or tetramethylammonium fluoride.

7. An etching agent composition according to any one of claims 1 to 6, wherein the material of the thin film having a high permittivity is a material comprising at least one compound selected from ZrO₂, Ta₂O₅, Nb₂O₅, Al₂O₃, HfO₂, HfSiON, TiO₂, ScO₃, Y₂O₃, La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃, a silicate material comprising any of these compounds and silicon or a nitride material comprising any of these compounds and nitrogen.

8. A process for etching a thin film having a high permittivity which comprises etching a thin film having a high permittivity using an aqueous solution comprising at least one acid selected from organic acids and inorganic acids and a fluorine compound.

9. A process for etching a thin film having a high permittivity according to claim 8, wherein a concentration of the organic acid is in a range of 0.01 to 15% by weight, and a concentration of the fluorine compound is in a range of 0.001 to 10% by weight in the aqueous solution.

10. A process for etching a thin film having a high permittivity according to any one of claims 8 and 9, wherein the organic acid is at least one acid selected from oxalic acid, citric acid, malonic acid, succinic acid, acetic acid and propionic acid.

11. A process for etching a thin film having a high permittivity according to claim 8, wherein the aqueous solution comprises 0.01 to 50% by weight of the inorganic acid and 0.001 to 10% by weight of the fluorine compound.

12. A process for etching a thin film having a high permittivity according to any one of claims 8 and 11, wherein the inorganic acid is at least one acid selected from sulfuric acid, nitric acid, hydrochloric acid, phosphoric acid and sulfamic acid.

13. A process for etching a thin film having a high permittivity according to any one of claims 8 to 12, wherein the fluorine compound is hydrofluoric acid, ammonium fluoride or tetramethylammonium fluoride.

14. A process for etching a thin film having a high permittivity according to any one of claims 8 to 13, wherein the material of the thin film having a high permittivity is a material comprising at least one compound selected from ZrO₂, Ta₂O₅, Nb₂O₅, Al₂O₃, HfO₂, HfSiON, TiO₂, ScO₃, Y₂O₃, La₂O₃, Ce₂O₃, Pr₂O₃, Nd₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃, a silicate material comprising any of these compounds and silicon or a nitride material comprising any of these compounds and nitrogen.
